(19) United States
(12) Patent Application Publication
(10) Pub. No.: US 2026/0079075 A1
(43) Pub. Date: Mar. 19, 2026

(54) METHOD FOR CALIBRATING VEHICLE HEADLIGHTS

(71) Applicant: MERCEDES-BENZ GROUP AG, Stuttgart (DE)

(72) Inventor: Sinan YARGELDI, Dettingen an der Erms (DE)

(21) Appl. No.: 19/109,815

(22) PCT Filed: Jul. 11, 2023
(86) PCT No.: PCT/EP2023/069204

§ 371 Date: Mar. 7, 2025

(30) Foreign Application Priority Data
Sep. 9, 2022 (DE) 10 2022 003 313.5

(51) Int. Cl. G01M 11/06; B60Q 1/076; F21S 41/60

(52) U.S. Cl. CPC G01M 11/065; B60Q 1/076; F21S 41/60

(57) ABSTRACT

Vehicle headlights are calibrated by identifying a misalignment of a predefined light distribution by analyzing images from at least one vehicle camera. In a first step, at least three recordings are preformed, which include a first recording with recording of a calibration pattern, a second recording without calibration pattern, and a third recording with recording of the inverse calibration pattern. In a second step the second recording is subtracted from the first and third recordings to clean the recordings from a present scene.

### BACKGROUND AND SUMMARY OF THE INVENTION

Exemplary embodiments of the invention relate to a method for calibrating vehicle headlights.

In principle, methods for calibrating vehicle headlights are known from the prior art. Such methods are necessary since the headlights of vehicles are often misaligned. Even in vehicles with automatic headlamp levelling, mechanical tension, thermal expansion or contraction and step losses of built-in stepper motors occur over time. All these factors lead to a gradual misalignment of the headlights.

Vertical misalignments, in particular, are a safety-relevant problem, since they can dazzle oncoming traffic or also lead to a reduction in your own range of vision. The headlight settings should thus be checked at regular intervals.

A method for generating a three-dimensional depth information map of the surroundings is thus known from DE 10 2020 007 613 A1. Here, light patterns are projected into the surroundings by means of a projector and recorded with a camera. The camera images can then be analyzed, wherein respective positions of feature points on their corresponding epipolar lines are recognized, and depth information relating to the three-dimensional map is obtained by determining a shifting of the feature points on these lines.

DE 10 2017 222 708 A1 shows further prior art. This describes a camera device for a vehicle that can carry out 3D surroundings detection. For this, at least two camera modules with at least partially overlapping detection regions are necessary. A 3D surroundings recording is carried out via a control unit and an evaluation unit and a point light projector using a “pseudo-noise pattern”.

In DE 10 2016 118801 A1, a method for adjusting the headlights of a vehicle is described. To do so, the individual light units of the headlights are controlled with a time delay in order to illuminate a scene. The scene is recorded over a predetermined period of time by means of a camera mounted on the vehicle. Deviations from a reference pattern can be calculated using the brightness distribution patterns resulting from the temporally offset control of the plurality of light units. The headlights can then be adjusted based on the deviations. For further prior art, reference can be made to DE10 2012 007 908 A1, DE 10 2016 006 391 A1, DE 10 2011 109 440 A1, DE 10 2015 203 889 A1, DE 10 2014 117 845 A1, DE 10 2017 117 594 A1 and DE 10 2020 000 292 A1.

Stepper motors are used to actively adjust the headlights, for example for headlamp levelling or bend lighting functions. These can adjust the light modules in the headlamp by a target angle. There are also approaches for adjusting the headlight settings automatically and in the field. For example, the light distribution of the headlights in the front of the vehicle can be recorded and analyzed using a driver assistance camera. Marked points on the cut-off line, such as an H0V0 point, are usually used for this type of evaluation. An attempt is made to recognize this in the image. In a further variant, light distributions specially designed for calibration can also be emitted in suitable situations, for example during a start-up or sleep process.

Based on a distance of pixels in the camera image to a calibrated reference point, vertical and horizontal difference angles can then be estimated and compared to a currently targeted adjustment. Vertical and horizontal misalignments can thus be compensated for. However, difficulties arise in uncontrolled or uncontrollable environmental conditions. These can affect the lighting conditions as well as the structure, shape and positioning of the illuminated surfaces. Different vehicles can also have different lighting systems. Here, this can result in differences in color and brightness distribution, individual pixel errors or inaccuracies in the optical path, which can lead to blurring and color shifts.

An evaluation algorithm can be based in particular on edge and maximum detections, but this can lead to imprecise calibration with inaccurate and variable feature extraction. In particular, safety-relevant accuracies of 0.1% according to ECE cannot here be robustly maintained. The introduction of high-resolution lighting systems in vehicles, based on LCD, DMD or μLED technologies, for example, also means that increasingly complex light distributions have to be projected.

Exemplary embodiments of the present invention are directed to a method for calibrating vehicle headlights which overcomes the disadvantages mentioned above.

In the core of the method according to the invention, at least three recordings are made in a first step, wherein a first recording with recording of a calibration pattern, a second recording without calibration pattern, and a third recording with recording of the inverse calibration pattern are carried out, and wherein in a second step the second recording is subtracted from the first and third recordings in order to clean the recordings from a present scene, wherein the calibration pattern comprises circles, wherein the position of the circles in the recording is known in advance, and wherein centers of the circles are arranged on horizontal lines, and by means of a straight line approximation each circle center is calculated, wherein it is determined whether the projection of the calibration pattern onto a suitable surface is carried out which is suitable for performing the calibration. Subtracting the images results in only the calibration pattern being visible in the image at any given time. This significantly simplifies the subsequent evaluation algorithm and makes it much more robust. Thus, a system for the automatic and highly accurate calibration of the adjustment of high-resolution headlamp systems in vehicles is provided.

With the method for calibrating vehicle headlights, a misalignment of a predefined light distribution is determined by analyzing images from at least one vehicle camera. The misalignment can then be compensated for, for example, by the installed stepper motors and redefining the zero position.

During calibration, the method can detect the structure of the vehicle front field and, in particular, output whether there is a wall in front of the vehicle. In doing so, the orientation of the wall can also be determined. All this information can be used to adapt projections from the headlamp to the existing front field.

Preferably, in a third step, the first and third recordings can be compared pixel by pixel in order to recognize a difference in brightness between pixels in the same position.

Here, according to an advantageous design, regions with very small differences in brightness can be depicted as grey regions. For example, regions outside the calibration pattern that are also in the camera image, i.e., in the recording, are marked as grey regions such that they do not need to be evaluated further. This has the advantage that a background scene is depicted in a grey value that is clearly separated from the projection regions of the headlight. In addition, the fusion of the two inverse images can eliminate the influence of optical crosstalk of activated pixels due to the imperfect optical channel. This can, for example, improve the subsequent localization of the circles.

The calibration pattern comprises circles, wherein the position of the circles in the recording is known in advance. High-resolution systems allow completely different projections to be used for calibration. Circles, for example, can thus be used, which have a number of advantages. For example, circles have a constant center point independent of the focus of the lighting system on the projection surface. Here, circles are also robust against distortions.

Centers of the circles are arranged on horizontal lines. Advantageously, the positioning of the circles in the light field of the headlight is known in advance. This can be done, for example, using known distances between parallel lines and a maximum permitted or a known distance between the centers.

A straight line approximation is used to calculate each circle center point, wherein it is determined whether the projection of the calibration pattern is carried out onto a suitable surface that is suitable for performing the calibration. For example, a required maximum rotation and the distances between the parallel lines can be used to ensure that the projection is onto a plane. Only in such a case should the calibration be advantageously continued.

According to a very advantageous development of the idea, it can here be provided that the vehicle camera is pre-calibrated. This is advantageous in order to carry out the previously described straight line approximation. A pre-calibrated vehicle camera is also advantageous for determining the position and rotation of the projection surface, i.e., the pose.

Here, according to an advantageous design, a pose of a projection plane can be determined by the calibration pattern being rotated horizontally and vertically and the pose of the projection plane being calculated by shifting the centers of the circles in the camera image. This is carried out in particular by assuming a flat projection surface. Thus, in a final step, the orientation of the headlight can be determined via a plane pose, via center point positions in the camera image and via known angular positions of the associated spotlight pixels, and the associated misalignment can be derived. The known angular positions can be a vertical angle to the center and/or a horizontal angle to the center of the circle.

The spotlight can also or alternatively be calibrated in advance in order to use the circles as feature points for triangulation of 3D coordinates. Advantageously, additional 2×3 recordings are here recorded once for the two shifted calibration patterns. In such a case, the corresponding pair of camera headlights is used in particular as a structured light system.

It is also conceivable to model projected circles as conical shells as they spread out in space. Here too, the position of the rings in three-dimensional space can be precisely determined, wherein setting the spotlight can be directly calculated back, since the installation position of the headlights is known and the light beam can thus be reconstructed.

A further advantageous design can provide for the pose to be determined using known angular positions of the calibrated vehicle camera, wherein flat surfaces and unsteady scenes can be recognized in order to adapt projections and/or animations for staging to the projection plane. Advantageously, this allows an exact measurement of the projection surface in front of the vehicle to be carried out, wherein not only planar surfaces such as a wall or the road surface, but also more complex and unsteady scenes can be recognized.

Furthermore, further advantages of the method according to the invention emerge from the remaining dependent claims and become clear from the exemplary embodiments, which are described in more detail below with reference to the figures.

### BRIEF DESCRIPTION OF THE DRAWING FIGURES

Here are shown:

FIG. 1 a possible embodiment of a calibration pattern;

FIG. 2 a further possible embodiment of a calibration pattern; and

FIG. 3 a possible course of the method.

### DETAILED DESCRIPTION

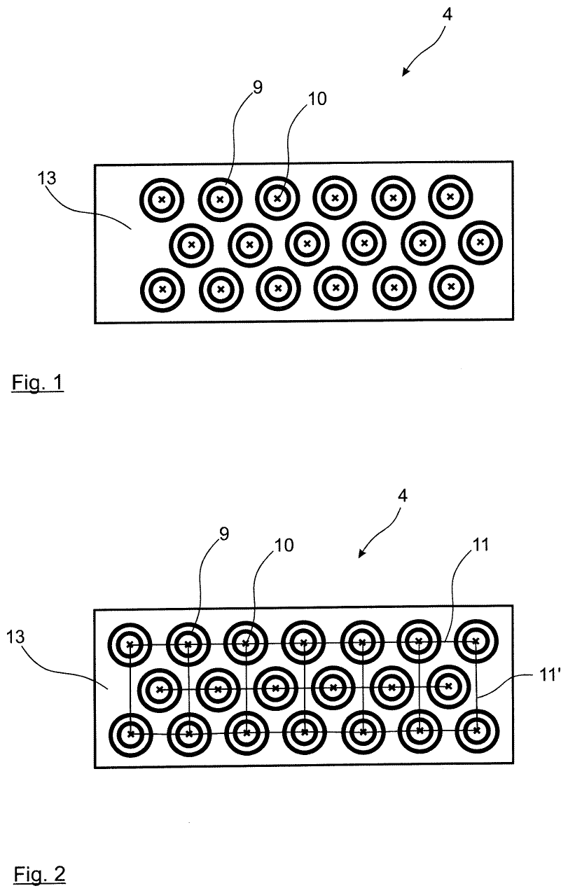

A possible embodiment of a calibration pattern 4 is shown in the depiction of FIG. 1. The calibration pattern 4 has individual circles 9 with a respective center 10. The surface shows, for example, the surface of a headlight 13

A further design variant of the method 1 can be seen in FIG. 2. In contrast to FIG. 1, the circles 9 are arranged differently. Furthermore, horizontal lines 11 can be seen which run along the centers 10. With such a calibration pattern 4, vertical lines 11′ can also be drawn for evaluation, which also connect two centers 10 to each other.

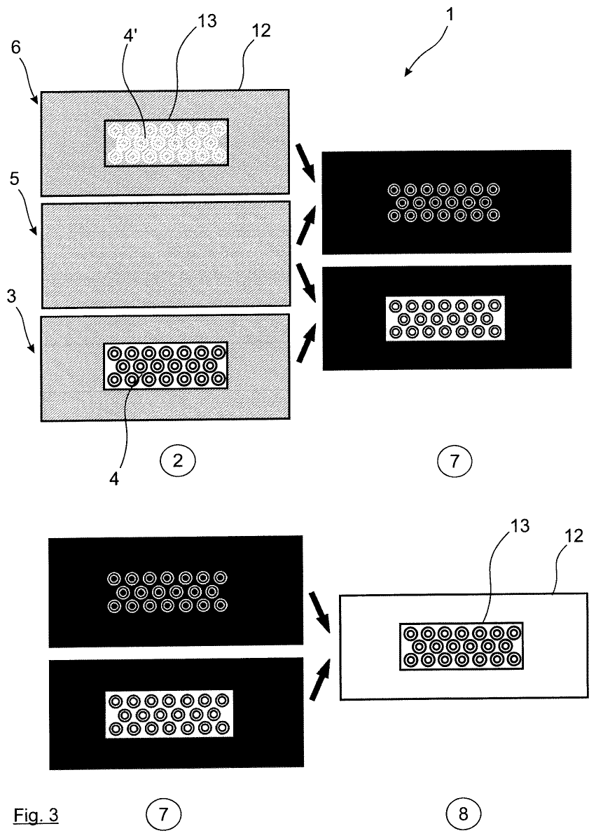

A possible course of the method 1 is depicted in FIG. 3. In the first step 2, three individual recordings are generated. A first recording 3 is carried out by capturing the calibration pattern 4. A second recording 5 is taken without the calibration pattern 4. A third recording 6 is carried out by recording the inverse calibration pattern 4′. In a second step 7, the second recording 5 is subtracted from the first and third recordings 3, 6. This allows the recordings 3 and 6 to be cleared of an individual scene. For reasons of clarity, the second step 7 is depicted twice. In a third step 8, the two recordings 3, 6 are compared to each other pixel by pixel in order to find a difference in brightness between pixels in the same position. Minor differences in brightness are shown as a grey region. This relates to the region outside the headlight 13, which is shown as a light dashed line.

The method therefore enables simple and automatic calibration of the headlights without additional hardware components. Advantageously, a high degree of accuracy can be achieved. Furthermore, the method is robust in relation to the ambient conditions and can be carried out autonomously and thus without the intervention of a driver or another operator. This results in an increase in safety and comfort. The profile of the projection space calculated during operation can also be used to adapt the projection of the vehicle, for example start-up animations for staging, to the existing projection surface.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-6. (canceled)

7. A method for calibrating vehicle headlights of a vehicle, the method comprising:
performing, using at least one vehicle camera of the vehicle, a first step comprising capturing a first recording of a light distribution of the vehicle headlights containing a calibration pattern, capturing a second recording of the light distribution of the vehicle headlights without the calibration pattern, and capturing a third recording of the light distribution of the vehicle headlights with an inverse of the calibration pattern, wherein the calibration pattern comprises circles, wherein a position of the circles in the first recording is known in advance, and wherein centers of the circles are arranged on horizontal lines;
performing a second step comprising subtracting the second recording from the first and third recordings to clean the first and third recordings from a scene in the captured first, second, and third recordings;
calculating, by a straight line approximation, a center of each of the circles;
determining, based on the straight line approximation, that a surface on which the light distribution of the vehicle headlights are projected is a suitable surface for the calibration of the vehicle headlights; and
calibrating, responsive to determining that the surface is a suitable surface for the calibration, the vehicle headlights.

8. The method of claim 7, further comprising:
comparing, in a third step, the first and the third recordings pixel by pixel to recognize a brightness different between pixels of a same position in the first and third recordings.

9. The method of claim 8, wherein regions with very low brightness differences are depicted as grey regions.

10. The method of claim 7, wherein the vehicle camera is pre-calibrated.

11. The method of claim 10, further comprising:
determining a pose of a projection plane by rotating the calibration pattern horizontally and vertically and calculating the pose of the projection plane by shifting the centers of the circles in the first recording.

12. The method of claim 11, wherein the pose is determined by known angular positions of the pre-calibrated vehicle camera, wherein flat surfaces and unsteady scenes are detected to adapt projections or animations for staging to the projection plane.
